(19) United States
(12) Patent Application Publication
(10) Pub. No.: US 2009/0213517 A1
(43) Pub. Date: Aug. 27, 2009

(54) SWITCHING DEVICE FOR SWITCHING AT LEAST ONE CURRENT

(75) Inventors: Karl-Hans Bärnklau, Weiden (DE); Josef Götz, Ebermannsdorf (DE); Michael Soukup, Kummersbruck (DE); Alf Wabner, Mittweida (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, 80333 Munchen (DE)

(21) Appl. No.: 12/088,775

(22) PCT Filed: Sep. 28, 2006
(86) PCT No.: PCT/EP2006/066847

§ 371 Date: Aug. 26, 2008

(30) Foreign Application Priority Data
Sep. 30, 2005 (DE) 10 2005 046 925.6

(51) Int. Cl. H02H 5/04; G01K 7/02; H01H 50/00; G08B 17/06

(52) U.S. Cl. 361/106; 374/163; 335/2; 340/593

(57) ABSTRACT

The invention relates to a device for switching at least one current includes a switching mechanism located in a switching chamber. The switching mechanism interrupts and connects a current path in an orderly fashion. Switching devices frequently have a protective function, e.g. relative to a power grid, and it is therefore desirable for supporting the protective function to identify faults and/or wear within the switching device. To this end, the switching device includes at least one temperature measuring unit that aids in detecting faults and wear within the switching device.

The invention relates to a switching device for switching at least one current, wherein the switching device includes a switching mechanism which is provided for orderly interrupting and connecting a current path. The invention also relates to a method for switching at least one electric current with a switching mechanism of a switching device, wherein a current path is interrupted and connected in an orderly fashion.

A switching device of the afore-described type is used in conjunction with electric power mains and components. The switching devices are provided, for example, as protection of the electric mains and components in the event of a short-circuit or an overload. A switching device can be implemented as an electromechanical switching device. The triggering criterion for the switching process is derived from a current measurement. A decision parameter can be defined or a triggering curve can be provided, which represent a triggering criterion for the switching device. If the current deviates from the expected value or nominal value within a certain tolerance range, then an message is generated or the protective mechanism is triggered.

In practical applications, suitable transducers measuring currents are employed in the switching device. The measurement values of these transducers are processed in an electronic evaluation unit. The evaluation unit checks if the current has exceeded a tolerance range or a threshold value. The evaluation can generally be based only on the current or on another electrical quantity accessible to the transducer. The electrical quantity is determined by electric components located outside the switching device, for example within the electric power grid. The components of the electric power grid can then be monitored with respect to a short-circuit or an overload; however, a potential malfunction of the switching device itself cannot be analyzed. An adverse effect on the switching device from the environment or wear of the switching mechanism of the switching device can also not be detected.

In practical applications, it is desirable to establish a basis for a decision, wherefrom the reliability or the operating state of the switching device can be inferred. In particular, this additional information about the switching device has increased significance, if the switching device is intended to be used for protecting the electric power grid.

DE 37 34 886 C1 discloses a device for monitoring the temperature of a switching element in a switching assembly, wherein for preventing harmful excess temperatures, the current path can be affected with a temperature sensor, when a predetermined value is exceeded. A device of this type for temperature monitoring is particularly advantageous when monitoring a switching assembly with an electronic monitoring device, wherein for example a current bus is to be protected against undesirable heating caused by increased current flow. In such switching arrangement, a relay circuit serves as an actuator for switching the corresponding current supply through the monitored current bus on and off. The device for monitoring the temperature is therefore also used for controlling the current.

It is an object of the invention to detect faults and wear inside a switching device in a simple and cost-effective manner.

The object in a switching device of the afore-described type is attained in that the switching device has at least one temperature measuring unit for fault detection and/or for detecting wear in the switching device. The object is also attained by a method of the afore-described type, wherein a fault and/or wear in the switching device and/or a serious environmental impact of the switching device is detected by at least one temperature measuring unit.

A temperature measuring unit is integrated in the switching device for fault detection and wear detection. The temperature measuring unit may be implemented as a temperature sensor or as a temperature measuring site. The temperature measuring unit can be strategically placed when the sensitive components inside the switching device are known. The component may be implemented as an electrical or a mechanical element. An elevated temperature of this component typically indicates unambiguously a certain fault or wear of the component, but may also be indicative of a fault or wear of another component due to their functional relationship. Detecting an elevated temperature of this unit then points to a particular fault or wear attribute which is typical for the corresponding component. Temperature measuring units can also be placed inside the switching device, allowing a number of conclusions about the switching device and its operating state, respectively. In addition, the message or the triggered protective measure(s) can be related to the appropriate underlying cause.

A possible component for measuring the temperature is, for example, the current path. Measurement data obtained on the component allow at least an inference regarding the operating state of the power grid outside the switching device, as well as inferences regarding the switching device itself and inferences regarding the operating environment.

An advantageous embodiment of the invention is a switching device with a temperature measuring device for measuring the temperature of the switching chamber. This embodiment is very general and measures a critical temperature which may be caused by an arbitrary component of the switching device or possibly even by an high outside temperature. Consequently, these effects may be documented in form of temperature measurement data. For example, an additionally installed temperature measuring unit which measures the housing temperature can be used to distinguish, if the heat source is located inside or outside the switching device. Other components which are particularly suited for use inside the switching device, can also be used for temperature measurements.

Advantageous embodiments may also include a temperature measuring unit employing for temperature measurements a thermocouple, a temperature-dependent resistor, a laser or a light emitting diode. Different advantages are attained depending on the use of the individual measurement elements. For example, with thermocouples or temperature-dependent resistors, the temperature can be monitored simultaneously at different locations or on different components, and the measurement data can be used cumulatively, meaning that, for example, a single measurement location is sufficient to monitor several critical locations inside the switching device. However, it is then not possible to determine the particular measurement locations with an elevated temperature. This type of multiple temperature measurements should therefore only be selected if this factor is not required for detecting or analyzing the fault or wear.

Components, in particular electric components, are typically required in an electronic unit for reliably monitoring the switching device. The electronic unit includes evaluation means for evaluating the measurement data of at least one temperature measuring unit. Advantageously, these evaluation means can be used for calculating the actual temperature of a component inside the switching device, in particular if a defined temperature gradient exists between the component to be monitored and of the temperature measuring unit. It is also feasible to implement a computational routine by which a temperature of one component can be deduced from the temperature actually measured on a different component. In this way, temperature gradients inside the switching device can be taken into account. For example, a temperature measuring device may be provided for measuring the temperature of the switching chamber, with the computational routine computing from these measurement data the temperature of the current path. It would be advantageous in this context to establish corresponding characteristic curves which uniquely associate the two temperatures with one another. The temperature of the current path or of other components, for example the switching mechanism, can then be deduced from a measurement of the housing temperature.

Advantageously, the temperature measuring unit includes optical means which can be used to measure temperature. Because optical methods permit a contactless temperature measurement, the temperature of those components can be measured, to which thermocouples or temperature-dependent resistors are difficult to attach or cannot be attached at all. For example, components of the switching mechanism may be scanned from a certain distance with a laser beam or the light of a light emitting diode. The temperature of, for example, the contact surface arranged in the switching mechanism can thereby be monitored. The temperature can be measured very locally, which prevents that the undesirable temperatures inside the switching device extend to other components. Moreover, faults and wear effects of the contact surfaces can be detected. The contact surfaces are typically manufactured from a material which is a superior electrical conductor, for example silver. The selection of this material is typically a tradeoff between the electric conductivity and hardness of the contract material. The choice of silver which has a very high electrical conductivity, has to be weighed against its abrasive properties or the loss of contact material. In the event of a loss of contact material or abrasion, the contact between the contact faces deteriorates and the switching device becomes highly resistive. As a result, the temperature of the contact faces increases steadily during operation. If the optically-based temperature measuring unit detects an increase in the temperature on the contact plates or similar components, then this leads to the conclusion that the operating characteristic of the switching device is deteriorating due to either abrasion or a loss of contact material. In this context, it would be advantageous to monitor or characterize the switching device with a temperature measuring unit, because the degree of wear of the switching device can also be deduced from a current-temperature curve. Conversely, the remaining useful service life of the switching device can be estimated, after which further use is no longer feasible. Using a measure for abrasion or the loss of contact material is also advantageous, because the useful service life of the switching devices can be quite different, depending if they are switched under load or without a load. A switching device that is switched under load has typically a service life of 0.01 to 10 million switching operations, wherein the number of possible switching operations in a switching device that is switched without a load, may be higher by, for example, a factor 100.

In another advantageous embodiment, messaging means for the measurement data of the temperature measuring unit are provided as triggering criterion for reporting an operating state and/or a service message. Reporting an operating state relates mainly to reporting an existing fault. A service message is important when monitoring the wear of the switching device, in particular of the switching mechanism. A corresponding message or service message of a critical temperature may entail an inspection or an exchange or triggering of the switching device. As mentioned above, reporting an operating state is also directed to detecting a fault, wherein a fault may be, for example, a loss of material in a switching element, contamination of the contacts or presence of a foreign object in the contact system. Such faults cannot be detected by measuring the current alone.

Additional advantageous embodiments and preferred modifications of the invention can be inferred from the description of the drawings and/or the dependent claims.

The invention will now be described and explained in more detail based on the exemplary embodiments illustrated in the figures.

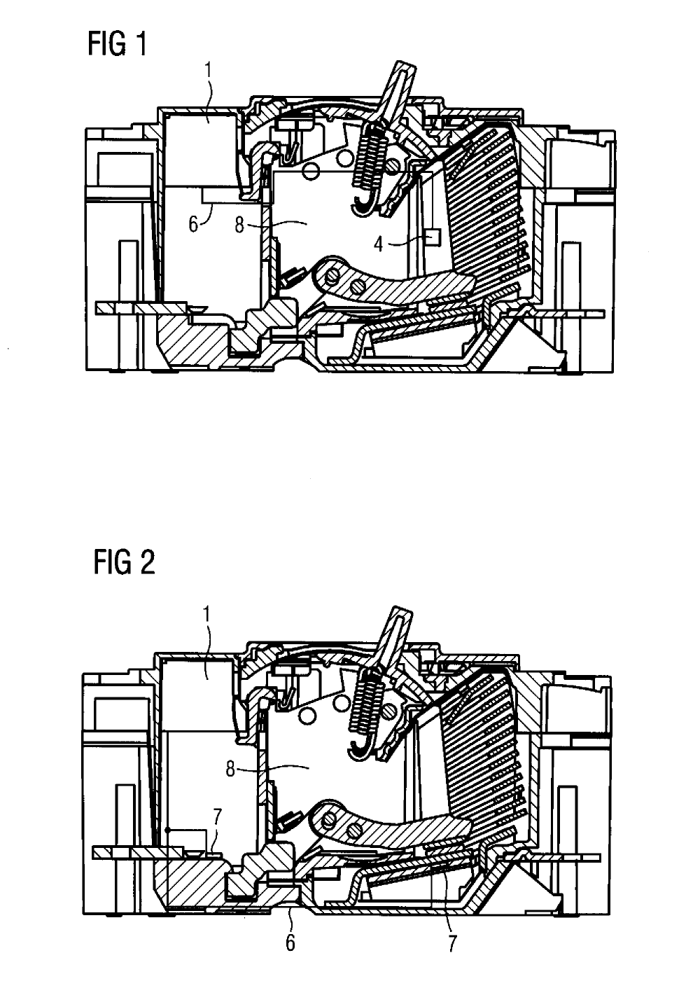

FIG. 1 illustrates a cross-sectional view of a first exemplary embodiment of an electromagnetic switching device,

FIG. 2 illustrates a cross-sectional view of a second exemplary embodiment of an electromagnetic switching device,

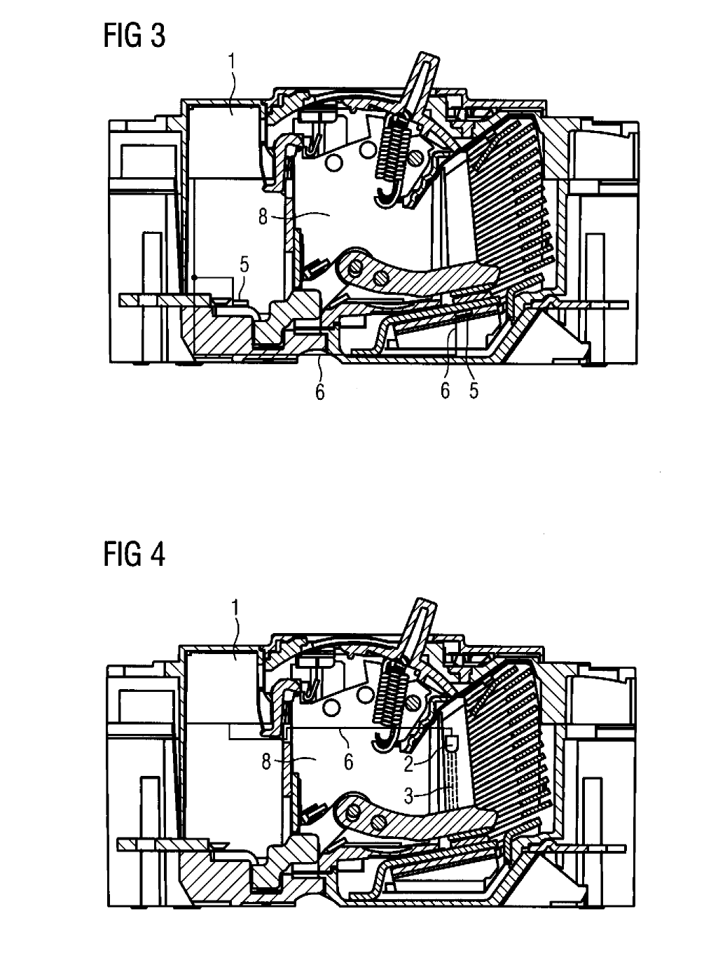

FIG. 3 illustrates a cross-sectional view of a third exemplary embodiment of an electromagnetic switching device,

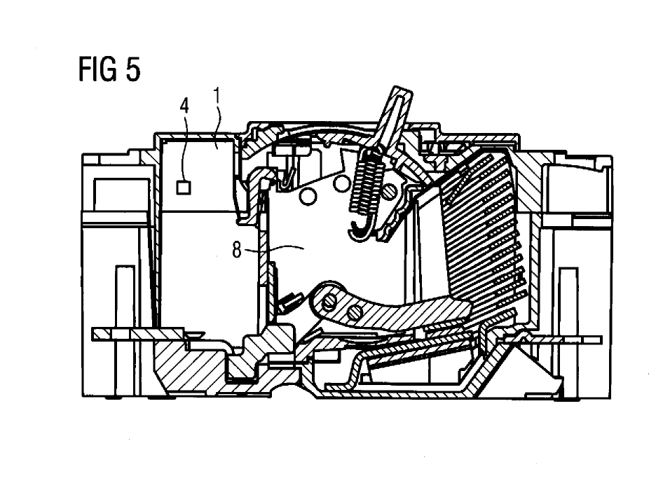

FIG. 4 illustrates a cross-sectional view of a fourth exemplary embodiment of an electromagnetic switching device, and

FIG. 5 illustrates a cross-sectional view of a fifth exemplary embodiment of an electromagnetic switching device.

FIG. 1 shows a cross-sectional view of a first exemplary embodiment of an electromagnetic switching device. The switching device includes an electronic unit 1 and a mechanical unit disposed in the interior space of the switching chamber 8. A temperature measuring unit 4 is formed on the wall of the switching chamber. The measurement data of the temperature measuring unit 4 are transmitted via an electric link to the electronic unit 1. The electronic unit 1 includes evaluation means for evaluating the measurement data received from the temperature measuring unit 4. More particularly, the evaluation means may include a computational routine which can be used to deduce from the temperature measurement the temperature of the contacts or of other mechanical or electrical components. This has the advantage that there is no longer a need to install a temperature measuring unit 4 on the contact faces or in the vicinity of the contact faces. Instead, the temperature gradient extending from the contacts to the temperature measuring unit 4 is characterized once and taken into consideration when computing the temperature. Advantageously, the temperature measuring unit 4 is moved as closely as possible near the contact faces. This eliminates a time delay between the time the temperature is actually attained and the time the temperature is measured.

FIG. 2 shows a cross-sectional view of a second exemplary embodiment of an electromagnetic switching device. Like in the first exemplary embodiment, this switching device includes an electronic unit 1 and a switching chamber. In this exemplary embodiment, a cumulative measurement method is selected. Two thermocouples 7 are attached inside the switching device, allowing a temperature measurement at two different locations. The voltage produced by the two thermocouples 7 represents the measurement quantity. An increase in the voltage above a predetermined threshold value leads to the diagnosis that an elevated temperature is present either at one or the other thermocouple 7, or at both thermocouples 7. If the electronic unit 1 is configured for evaluating two different measurement locations, then both thermocouples 7 can be monitored separately, and it can be unambiguously determined which of the two thermocouples reports an elevated temperature.

FIG. 3 shows a cross-sectional view of a third exemplary embodiment of an electromagnetic switching device. The design of the switching device of the third exemplary embodiment corresponds to the design of the switching device of the second exemplary embodiment, with the difference that temperature-dependent resistors 5 are used as temperature measuring units instead of the thermocouples 7. The possible operating modes have already been described in conjunction with the second exemplary embodiment, with the relevant measurement quantity in the third exemplary embodiment being the ohmic resistance of the temperature-dependent resistors 5.

FIG. 4 shows a cross-sectional view of a fourth exemplary embodiment of an electromagnetic switching device. In this exemplary embodiment, the optically-based temperature measuring unit 2 is likewise connected via a line with the electronic unit 1. The measurement data are recorded by optically scanning a component susceptive to heating. The temperature measuring unit 2 can include a laser LED or a conventional LED. A conventional LED can be used if the distance traveled by the light beam 3 to the measurement point or the measurement surface is small. Otherwise, if the measurement location is difficult to reach or is located far from the temperature measuring unit 2, then a laser LED with superior focusing characteristic may be used. With this approach, temperatures of components that either move or are difficult to reach can also be measured. In particular, the temperature measuring unit 2 can be configured explicitly for detecting blackening of the contact elements. It is then no longer necessary to determine the exact temperature, and it is instead sufficient to measure the light intensity of the reflected light and use the degree of blackening of the contact face as a triggering criterion.

FIG. 5 shows a cross-sectional view of a fifth exemplary embodiment of an electromagnetic switching device. An integrated temperature measuring unit 4 disposed inside the electronic unit 1 is used to measure the temperature in the switch. This approach requires measurements characterizing the temperature behavior of the switch, but represents a very cost-effective variant for temperature measurements.

In summary, the invention is directed to a switching device for switching at least one current, wherein the switching device has a switching mechanism inside a switching chamber for interrupting and connecting a current path in an orderly fashion. Switching devices frequently assume a protective function, for example, with respect to a power grid. For this reason, fault and wear detection inside the switching device is desirable for supporting the protective function. To this end, the switching device is modified in that at least one temperature measuring unit for detecting fault and wear is employed inside the switching device.

1.-18. (canceled)

19. A switching device for switching an electric current, comprising:
at least one temperature measuring unit for detecting a fault in the switching device; and
a switching mechanism operatively connected to the temperature measuring unit for interrupting a current path in the switching device in response to a fault detection by the temperature measuring unit.

20. The switching device of claim 19, wherein the fault is a mechanical defect or wear, or both.

21. The switching device of claim 19, wherein the temperature measuring unit is configured for measuring a temperature of the current path.

22. The switching device of claim 19, further comprising a housing for defining a switching chamber, said temperature measuring unit being configured for measuring a temperature of the switching chamber or a housing temperature, or both.

23. The switching device of claim 19, wherein the temperature measuring unit is a member selected from the group consisting of thermocouple, temperature-dependent resistor, laser, light emitting diode, and a combination thereof.

24. The switching device of claim 19, further comprising an evaluation unit coupled to the temperature measuring unit, said evaluation unit being constructed to determine a triggering criterion in response to measurement data of the temperature measuring unit for actuating the switching mechanism to interrupt the current path.

25. The switching device of claim 24, wherein the evaluation unit includes messaging means responsive to the triggering criterion for reporting an operating state or a service message, or both.

26. The switching device of claim 25, wherein a reported operating state or service message is displayed locally or at a central location, or both.

27. The switching device of claim 19, further comprising an external evaluation unit for evaluating measurement data of the temperature measuring unit external of the switching device.

28. The switching device of claim 19, further comprising a current sensor for monitoring an electric current.

29. The switching device of claim 23, further comprising a triggering unit (ETU) or a monitoring module, or both.

30. The switching device of claim 19, constructed in the form of an electromechanical switching device.

31. A method for switching an electric current, comprising the steps of:
detecting a fault in a switching device as a result of a temperature increase measured by at least one temperature measuring device; and
interrupting an electric current path in the switching device by means of a switching mechanism in response to the detected fault.

32. The method of claim 31, wherein the detecting step includes the step of ascertaining a quantity characteristic of a current path temperature, a switching chamber temperature or a housing temperature, or a combination thereof.

33. The method of claim 32, wherein the characteristic quantity is measured with a thermocouple, a temperature-dependent resistor, a laser or a light emitting diode, or a combination thereof.

34. The method of claim 31, further comprising the steps of deriving from measurement data of the temperature measuring unit a triggering criterion, and interrupting the electric current path based on the triggering criterion.

35. The method of claim 31, further comprising the steps of deriving from measurement data of the temperature measuring unit a triggering criterion, and transmitting a report of an operating state or a service message, or both, based on the triggering criterion.

36. The method of claim 35, wherein the report is displayed locally or at a central location, or both.

37. The method of claim 31, further comprising the step of monitoring an electric current with a current sensor.

38. The method of claim 31, wherein this switching device is an electromechanical switching device.
